(19) United States
(12) Patent Application Publication
(10) Pub. No.: US 2011/0141178 A1
(43) Pub. Date: Jun. 16, 2011

(54) PRINTING APPARATUS AND METHOD FOR PRINTING

(75) Inventors: Kiyoshi Kawai, Shiojiri-shi (JP); Tsuneo Kasai, Azumino-shi (JP); Hirokazu Kasahara, Okaya-shi (JP)

(73) Assignee: SEIKO EPSON CORPORATION, Shinjuku-ku (JP)

(21) Appl. No.: 12/968,211

(22) Filed: Dec. 14, 2010

(30) Foreign Application Priority Data
Dec. 16, 2009 (JP) 2009-284863

(51) Int. Cl. B41J 29/38

(52) U.S. Cl. 347/14

(57) ABSTRACT

A printing apparatus which prints a print image onto a printing medium based on image data, includes a plurality of nozzles which discharge ink onto the printing medium based on the image data while relatively moving with respect to the printing medium, an intensity detector which irradiates the printing medium with irradiation light to detect a light intensity for detection which is an intensity of light through the printing medium based on the irradiation light, and a defective nozzle detector which detects a bias of a distribution of dots with the ink formed on the printing medium based on the light intensity for detection to judge whether a defective nozzle is caused based on the bias of the distribution of the dots.

### INCORPORATED BY REFERENCE

The entire disclosure of Japanese Patent Application No. 2009-284863, filed Dec. 16, 2009 is expressly incorporated by reference herein.

### BACKGROUND

1. Technical Field

The present invention relates to a printing apparatus and a method for printing. In particular, the invention relates to a technique of printing a print image onto a printing medium based on image data.

2. Related Art

In an ink jet printing apparatus, some nozzles of which ink discharge condition is defective (hereinafter, also referred to as defective nozzle) are caused in some reason or other among a plurality of nozzles of a printing head to not properly discharging ink. As the defective ink discharge condition, conditions where ink is not discharged, a discharge amount of ink or a landing position of ink is inappropriate, and the like are exemplified. As techniques of detecting a defective nozzle in the past, techniques described in JP-A-2006-199048 and JP-A-2006-205742 are known, for example.

However, the technique disclosed in JP-A-2006-199048 is a technique of detecting a defective nozzle by an RGB sensor which is sensitive to each of R, G and B. With the technique disclosed in JP-A-2006-199048, although defective nozzles for discharging inks of CMY which are complementary colors of RGB and K can be detected with high accuracy, the defective nozzles for discharging inks of which color phases are different from RGB, CMY and K are unfortunately detected with low accuracy. On the other hand, with the technique disclosed in JP-A-2006-205742, there arises a problem that the number of sensors for detecting a defective nozzle is increased as types of inks included in the printing apparatus are increased.

### SUMMARY

An advantage of some aspects of the invention is to solve at least one of the issues mentioned above and to achieve the advantage in forms of the following modes or Application Examples.

### Application Example 1

A printing apparatus according to an aspect of the invention which prints a print image onto a printing medium based on image data includes a plurality of nozzles which discharge ink onto the printing medium based on the image data while relatively moving with respect to the printing medium, an intensity detector which irradiates the printing medium with irradiation light to detect a light intensity for detection which is an intensity of light through the printing medium based on the irradiation light, and a defective nozzle detector which detects a bias of a distribution of dots with the ink formed on the printing medium based on the light intensity for detection to judge whether a defective nozzle is caused based on the bias of the distribution of the dots.

With the printing apparatus, whether the defective nozzle is caused can be judged while printing of image data, for example, printing of a normal image (figure photographs, scenery photographs, and graphics) is performed.

### Application Example 2

In the printing apparatus according to the Application Example 1, it is preferable that the printing apparatus further include a defective nozzle identification unit which prints a predetermined evaluation pattern image onto a printing medium to identify the defective nozzle based on the evaluation pattern image when the defective nozzle detector judges that there is a probability that the defective nozzle is caused. Further, in the printing apparatus, it is preferable that the evaluation pattern image be an image in which at least a part of each dot formation region on which each ink discharged from each of the plurality of nozzles lands on the printing medium to form ink dots in each region is not superimposed with other dot formation regions, and the defective nozzle identification unit irradiate the evaluation pattern with the irradiation light to identify the defective nozzle based on a light intensity for identification which is an intensity of light corresponding to each of the dot formation regions among lights through the evaluation pattern based on the irradiation light.

With the printing apparatus, when it is judged that there is a probability that a defective nozzle is caused by a normal image printing, the defective nozzle is identified by printing an evaluation pattern image. Therefore, the defective nozzle can be precisely identified while smoothly performing the normal image printing.

### Application Example 3

In the printing apparatus according to Application Example 1 or Application Example 2, it is preferable that the defective nozzle detector generate a light amount distribution which is a distribution of a light amount based on the light amount obtained by integrating the light intensity for detection in the relative movement direction to detect the bias of the distribution of the dots based on the light amount distribution.

With the printing apparatus, a bias of dots is detected by a light amount distribution of a light amount obtained by integrating the light intensity for detection in the relative movement direction. Therefore, an average bias of dots on a print image can be detected.

### Application Example 4

In the printing apparatus according to any of Application Example 1 through Application Example 3, it is preferable that the irradiation light contain a wavelength component in a visible light region, the intensity detector detect an intensity of light having the wavelength component in the visible light region as the light intensity for detection, and the ink be ink which absorbs light having the wavelength component in the visible light region and light having a wavelength component in an ultraviolet light region.

With the printing apparatus, printing using ink which absorbs light having a wavelength component in a visible light region and light having a wavelength component in an ultraviolet light region can be performed.

### Application Example 5

In the printing apparatus according to any of Application Example 1 through Application Example 4, it is preferable that the irradiation light contain the wavelength component in the ultraviolet light region, the intensity detector detect an intensity of light having the wavelength component in the visible light region as the light intensity for detection, and the ink include ink which reflects the light having the wavelength component in the visible light region as light having the wavelength component in the visible light region, and reflects the light having the wavelength component in the ultraviolet light region as light having the wavelength component in the ultraviolet light region.

With the printing apparatus, printing using ink which reflects the light having the wavelength component in the visible light region as light having the wavelength component in the visible light region, and reflects the light having the wavelength component in the ultraviolet light region as light having the wavelength component in the ultraviolet light region can be performed.

### Application Example 6

In the printing apparatus according to Application Example 4 or Application Example 5, it is preferable that ink which absorbs light having the wavelength component in the visible light region and light having the wavelength component in the ultraviolet light region be ink including cyan (C) ink, magenta (M) ink, and yellow (Y) ink.

With the printing apparatus, printing using ink including cyan (C) ink, magenta (M) ink, and yellow (Y) ink as ink which absorbs light having the wavelength component in the visible light region and light having the wavelength component in the ultraviolet light region can be performed.

### Application Example 7

In the printing apparatus according to Application Example 5 or Application Example 6, it is preferable that ink which reflects the light having the wavelength component in the visible light region as light having the wavelength component in the visible light region and reflects the light having the wavelength component in the ultraviolet light region as light having the wavelength component in the visible light region include ink of fluorescent color.

With the printing apparatus, printing using fluorescent ink can be performed.

### Application Example 8

In the printing apparatus according to any of Application Example 1 through Application Example 7, it is preferable that the defective nozzle detector judge whether the defective nozzle is caused based on the bias of the distribution of the dots and the image data.

With the printing apparatus, the bias of the distribution of the dots and original image data are used for detecting a defective nozzle. Therefore, the defective nozzle can be detected while judging whether the detected bias of the distribution of the dots is caused by nature of the original image data.

### Application Example 9

A method for printing a print image onto a printing medium based on image data including: discharging ink onto the printing medium by using a plurality of nozzles based on the image data while relatively moving with respect to the printing medium; detecting a light intensity for detection which is an intensity of light through the printing medium based on the irradiation light by irradiating the printing medium with irradiation light; detecting a bias of a distribution of dots with the ink formed on the printing medium based on the light intensity for detection; and judging whether a defective nozzle is caused based on the bias of the distribution of the dots.

With the method for printing, whether a defective nozzle is caused can be judged while the image data is printed.

### BRIEF DESCRIPTION OF THE DRAWINGS

The invention will be described with reference to the accompanying drawings, wherein like numbers reference like elements.

FIG. 1 is a descriptive view illustrating a schematic configuration of a printer.

FIGS. 2A and 2B are descriptive views illustrating configurations of a printer head, a light source, and a photosensor.

FIG. 3 is a flowchart illustrating a flow of a printing processing.

FIG. 4 is a descriptive view for explaining rasters and dot number data.

FIG. 5 is a sensor spectral sensitivity spectrum illustrating sensitivity characteristics of the photosensor.

FIG. 6 is a table for explaining a relationship between irradiation lights and reflected lights.

FIGS. 7A and 7B are descriptive views for explaining a light amount distribution.

FIG. 8 is a flowchart for explaining a flow of a defective nozzle identification processing.

FIG. 9 is a descriptive view for explaining an evaluation pattern.

### DESCRIPTION OF EXEMPLARY EMBODIMENTS

Mode for carrying out the invention will be described based on an embodiment.

### A. Embodiment

### A1. Configuration of Printer

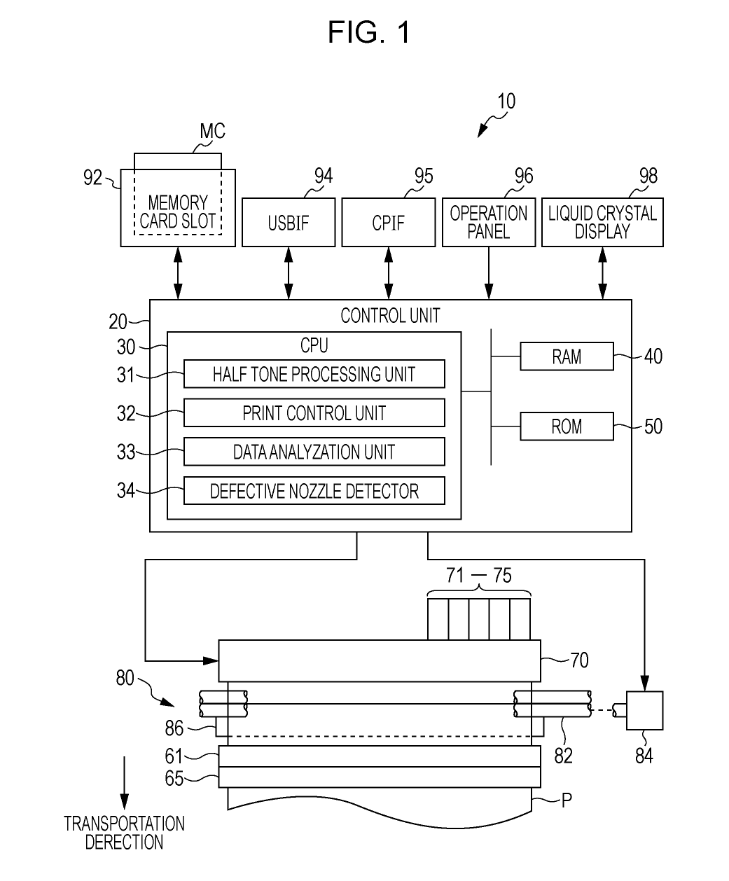

FIG. 1 is a descriptive view illustrating a schematic configuration of a printer 10 as an embodiment of the present application. The printer 10 is an ink jet line printer. As shown in FIG. 1, the printer 10 includes a control unit 20, a printer head 70, ink cartridges 71 through 75, a sheet feeding mechanism 80, a light source 61, and a photosensor 65. The ink cartridges 71 through 75 accommodate cyan (C) ink, magenta (M) ink, yellow (Y) ink, black (K) ink, and fluorescent color ink (F), respectively. The fluorescent color ink (F) is not particularly limited in the embodiment and may be any inks of fluorescent colors such as a cyan-based color, a magenta-based color, and a yellow-based color. Further, the fluorescent color ink (F) is also referred to as fluorescence (F) simply. In addition, inks of the cyan (C), the magenta (M), the yellow (Y), and the black (K) are collectively referred to as normal ink.

The printer head 70 is a printer head of a line head type. Rows of nozzles for discharging inks are arranged on a lower surface of the printer head 70 in the transportation direction. Each nozzle row is configured of nozzles which are arranged generally in a row for each ink color. Each nozzle includes a piezoelectric device. A vibration of the piezoelectric device is controlled by adjusting a voltage applied to the piezoelectric device so that ink droplets are discharged. The printer head 70 is described in detail later.

The sheet feeding mechanism 80 includes a sheet feeding roller 82, a sheet feeding motor 84 and a platen 86. The light source 61 is a light source which emits light having a wavelength component in an ultraviolet light region (hereinafter, referred to as ultraviolet light simply) and light having a wavelength component in a visible light region (hereinafter, referred to as visible light simply) as irradiation light. In the embodiment, a UV lamp which emits ultraviolet light and a white color LED which emits visible light are combined so as to be used as the light source 61. The photosensor 65 is a photosensor having sensitivity to regions from the visible light region to the ultraviolet light region. The photosensor 65 receives reflected light which is described later and measures energy of the received reflected light (hereinafter, also referred to as energy simply). In the embodiment, a charge coupled device (CCD) is used as the photosensor. Further, when the energy is measured, a wavelength component of the received light is selected and the energy of the light having the selected wavelength component can be measured.

The sheet feeding motor 84 rotates the sheet feeding roller 82 so as to transport a print sheet P passing through between the printer head 70 and a flat plate-form platen 86 in the direction perpendicular to an axis direction of the sheet feeding roller 82. At this time, each nozzle provided on the printer head 70 discharges ink so as to form dots with the ink onto the print sheet P. Thereafter, the print sheet P on which dots with ink are formed is transported by the sheet feeding mechanism 80 and passes through a light path of the irradiation light emitted by the light source 61. Then, the light source 61 irradiates the print sheet P with the irradiation light so that the photosensor 65 receives light returned through the print sheet P. The irradiation light returns through the print sheet P based on two different principles. The light returned from the print sheet P based on the principles is also collectively referred to as reflected light in the embodiment. The two principles are described later.

The control unit 20 includes a CPU 30, a RAM 40, and a ROM 50 and controls operations of the above printer head 70 and the sheet feeding motor 84. The CPU 30 develops control programs stored in the ROM 50 on the RAM 40 and executes the programs so as to operate as a halftone processing unit 31, a print control unit 32, a data analyzation unit 33, and a defective nozzle detector 34. The halftone processing unit 31 performs a halftone processing on image data for printing (hereinafter, also referred to as image data D) which is input to the printer 10. The print control unit 32 outputs a control signal to the printer head 70. The control signal is a signal for controlling discharging of ink from each nozzle based on the image data D which has been subjected to the halftone processing. In addition, the print control unit 32 controls the entire operation of the sheet feeding mechanism 80. The data analyzation unit 33 and the defective nozzle detector 34 are described in detail later.

Further, a memory card slot 92, a USB interface 94, a computer interface 95 (hereinafter, also referred to as CPIF 95), an operation panel 96 and a liquid crystal display 98 are connected to the control unit 20. A memory card MC is inserted to the memory card slot 92. The USB interface 94 connects equipment such as a digital camera or the like. The computer interface 95 is connected to a computer for transmitting image data for printing to the printer 10. With the operation panel 96, various operations relating to printing are performed. A user interface (UI) is displayed on the liquid crystal display 98.

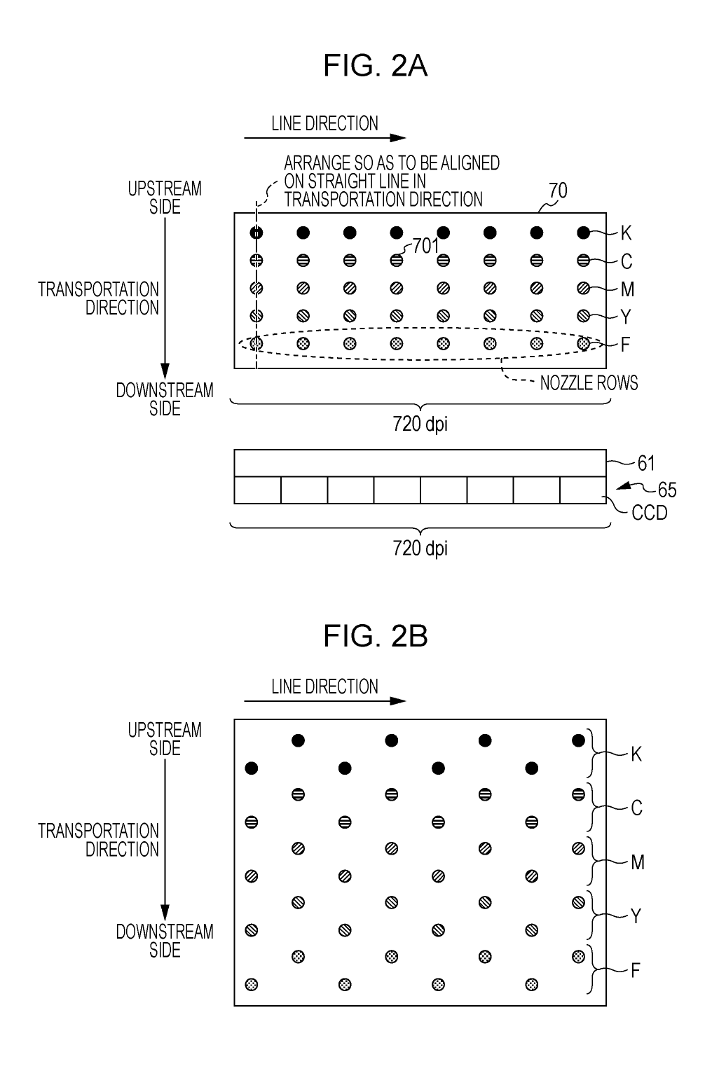

FIGS. 2A and 2B are descriptive views illustrating configurations of the printer head 70, the light source 61, and the photosensor 65. As shown in FIG. 2A, the printer head 70 according to the embodiment includes a plurality of nozzles 701 which control vibrations of the piezoelectric devices so as to discharge ink. The nozzles 701 are arranged such that each of nozzles which discharge the black (K) ink, nozzles which discharge the cyan (C) ink, nozzles which discharge the magenta (M) ink, nozzles which discharge the yellow (Y) ink, and nozzles which discharge the fluorescent (F) ink are arranged in a row. Each row including the nozzles is referred to as a nozzle row. Resolution of each nozzle in the direction (hereinafter, also referred to as line direction) perpendicular to the transportation direction of the sheet (that is, resolution of the printer head 70 in the line direction) is 720 dpi. The nozzle rows each of which corresponds to each color are arranged in parallel in the transportation direction of the print sheet P. Further, in the embodiment, one row of the nozzles 701 is arranged for each color of ink for convenience of description. However, as shown in FIG. 2B, two or more rows of nozzles may be arranged for each color of ink in a zigzag form.

The photosensor 65 is arranged so as to sufficiently receive reflected light from the print sheet P in consideration of a relative positional relationship with the light source 61. The photosensor 65 is formed with a CCD line sensor and a resolution thereof in the line direction is 720 dpi. The resolution of the CCD line sensor may be arbitrarily set in a possible range as long as the resolution is equal to or not lower than the resolution of the printer head 70 in the line direction. If image data D for printing and information relating to the print number are input to the printer 10 having such configuration from any of the memory card slot 92, the USB interface 94, and the computer interface 95, the printer 10 starts a printing processing based on the input image data. Hereinafter, the printing processing will be described.

### A2. Printing Processing

Next, the printing processing performed by the printer 10 is described. The printing processing in the embodiment is a processing in which printing is performed while an error (hereinafter, also referred to as nozzle defect) of a discharge condition of ink from each nozzle 701 provided on the printer head 70 is being detected. As the nozzle defect, for example, a condition where a nozzle is clogged with ink solidified in the nozzle and a prescribed amount of ink is not discharged, further ink is not discharged at all, or ink more than the prescribed amount is discharged is exemplified. In addition, a condition where a nozzle is deformed for some reason and ink is not discharged in a prescribed discharging direction is exemplified. Such nozzle having an error in the ink discharge condition is referred to as a defective nozzle. In the printing processing, printing is performed based on the image data D while detecting whether a defective nozzle is caused.

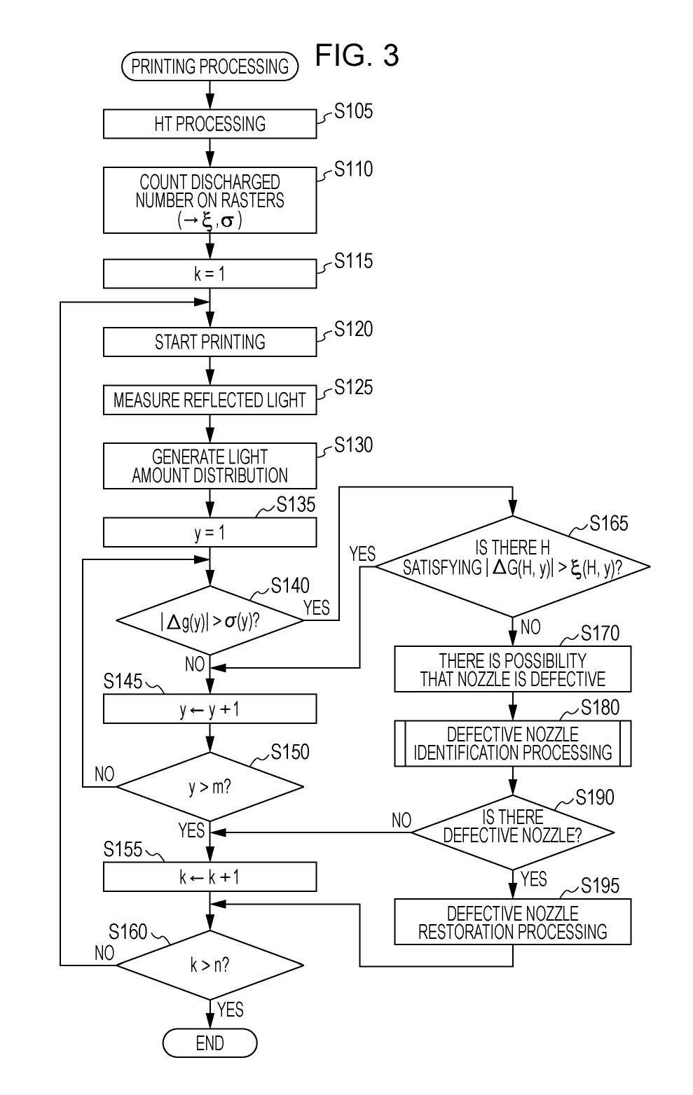

FIG. 3 is a flowchart illustrating a flow of the printing processing performed by the printer 10. As described above, if image data D and information relating to the print number (hereinafter, also referred to as print number information) are input to the printer 10, the CPU 30 starts the printing processing. In the embodiment, information indicating that printing of n sheets (n is an integer of equal to or not lower than 1) is performed based on the input image data D (hereinafter, also referred to as set number value n) is included as the print number information.

If the printer 10 inputs the image data D and the print number information, the halftone processing is performed based on the image data D (step S105). The halftone processing is performed by using a known halftone processing techniques such as a dithering method and an error diffusion method. With the halftone processing, the image data D becomes dot pattern data for each ink color. After the halftone processing, the CPU 30 counts the number of dots formed on each raster for each ink color on the image data D as a dot pattern. Then, dot number data which is data relating to the number of dots on each raster for each color is generated.

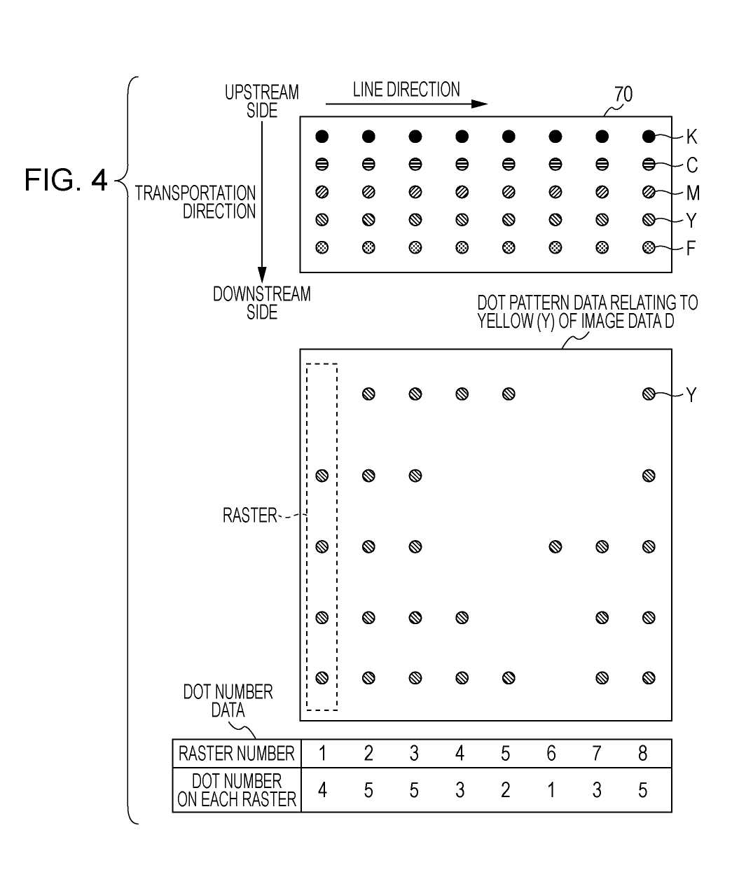

FIG. 4 is a descriptive view for explaining rasters and dot number data. In FIG. 4, the printer head 70 is also illustrated in order to facilitate understanding. Further, in FIG. 4, dot pattern data of yellow (Y) and dot number data corresponding to the dot pattern data are illustrated as a specific example. As shown in the dot pattern data of FIG. 4, rasters are rows of dots in the transportation direction. A raster number is corresponded to each raster in the line direction. As shown in FIG. 4, the dot number data is data relating to the number of dots for each raster in the dot pattern data. In the specific example, there are four yellow dots in the raster number 1 in the dot pattern data of yellow (Y), for example. Accordingly, “4” is stored in the raster number 1 in the dot number data. In such a manner, the dot number data is obtained by counting the number of dots on each raster in the dot pattern data for each ink color to make data. Therefore, the dot number data is generated for each of five dot patterns of K, C, M, Y, and F from one image data D. In other words, the dot number data is data indicating the number of ink dots discharged from each nozzle in the printing processing of the image data D.

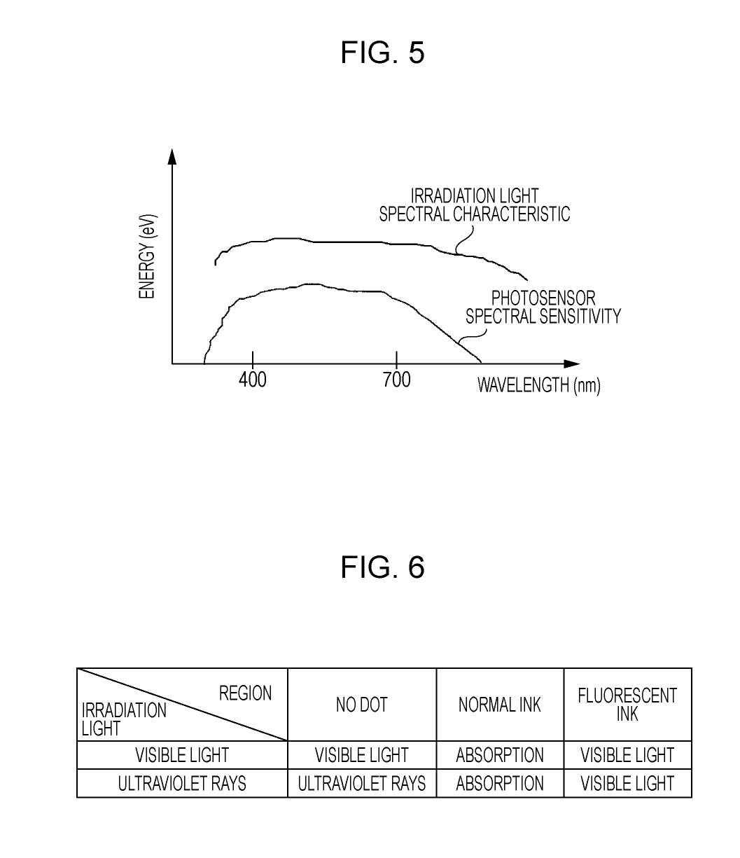

If the dot number data is generated in such a manner, the CPU 30 sets a print number value k used for counting the print number as k=1 (step S115 in FIG. 3). After the print number value k as set to k=1, the CPU 30 starts printing based on the image data D (step S120). To be more specific, operations of the printer head 70 and the sheet feeding mechanism 80 are controlled so as to form dots with ink onto the print sheet P based on the image data D (dot pattern data) which has undergone to the halftone processing. When printing is started, the CPU 30 controls the light source 61 so as to irradiate the print sheet P on which dots have been formed with ink with irradiation light. At the same time, the CPU 30 controls the photosensor 65 so as to receive reflected light from the print sheet P and measures energy of the reflected light (step S125). FIG. 5 is a sensor spectral sensitivity spectrum showing spectrum characteristics of the irradiation light by the light source 61 used in the embodiment and sensitivity characteristic of the photosensor 65 also used in the embodiment. As is seen from FIG. 5, a wavelength component of the irradiation light and spectrum sensitivity of the photosensor 65 have substantially same wavelength region. Further, although an energy intensity of the reflected light based on the irradiation light is different from the energy intensity of the irradiation light, the reflected light and the irradiation light have wavelength components in substantially same wavelength region. Accordingly, the energy of the reflected light can be measured by using the irradiation light and the photosensor 65 as shown in FIG. 5.

As the reflected light in the embodiment, there are the following reflected lights. That is, there are reflected light from the print sheet P (region on which ink dots are not formed (hereinafter, also referred to as “no-dot region”)) based on the irradiation light, reflected light through a region on which ink dots of CMYK (that is, dots of inks other than the fluorescent ink (F)) are formed (hereinafter, also referred to as “normal dot region”) on the print sheet P, and reflected light through a region on which ink dots with the fluorescence (F) are formed (hereinafter, also referred to as “fluorescent ink dot region”) on the print sheet P. FIG. 6 is a table for explaining a relationship between irradiation lights and reflected lights. In FIG. 6, the irradiation light is distinguished between the visible light (light source: white color LED) and the ultraviolet light (light source: UV lamp). Further, types of the reflected lights through the above three regions are illustrated for each irradiation light in FIG. 6. As shown in FIG. 6, if the no-dot region is irradiated with each of the visible light and the ultraviolet light as the irradiation lights, the no-dot region reflects each of the visible light and ultraviolet light as the reflected lights. If the normal ink region is irradiated with each of the visible light and the ultraviolet light as the irradiation lights, the normal ink region absorbs both of the irradiation lights. It is to be noted that the normal ink region absorbs the irradiation lights not all but absorbs the irradiation lights more than those absorbed by other regions. If the fluorescent ink region is irradiated with the visible light as the irradiation light, the fluorescent ink region reflects the visible light as the reflected light. Further, if the fluorescent ink region is irradiated with the ultraviolet light as the irradiation light, a fluorescent material contained in the fluorescent ink once absorbs the ultraviolet light so as to emit the visible light. In the embodiment, such a phenomenon that the ultraviolet light is absorbed and the visible light is emitted is also referred to as “reflection” for the convenience of explanation.

Printing of the image data D for one frame is completed and energy of the reflected light corresponding to the image data D for one frame is measured. Then, the CPU 30 calculates an integrated value obtained by integrating a value of the measured energy for each raster of the image data D. The integrated value is also referred to as light amount, hereinafter. In this case, only value of the energy of the reflected light having the wavelength component in the visible light region among the received reflected lights is used for the integration. That is to say, an integrated value of the energy of the visible light as the reflected light is calculated for each raster. Thereafter, the CPU 30 generates a light amount distribution by arranging the light amount for each raster in the line direction to make a graph (step S130).

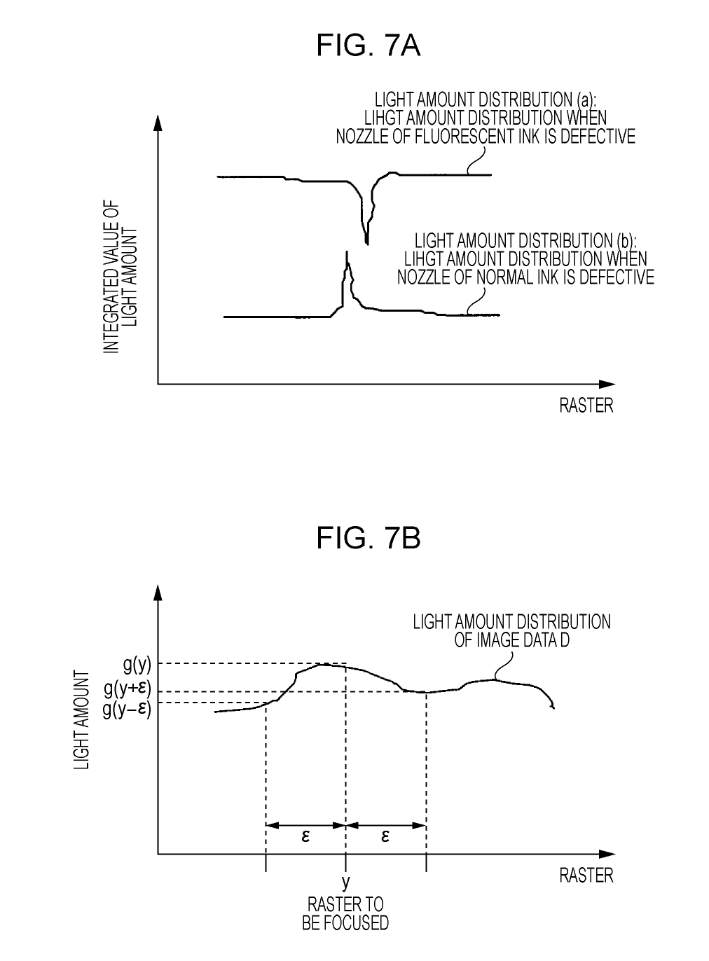

FIGS. 7A and 7B are descriptive views for explaining the light amount distribution. As a specific example, FIG. 7A illustrates a light amount distribution (hereinafter, also referred to as light amount distribution (a)) when one of nozzles corresponding to the fluorescent ink is defective and does not discharge ink in a case where an image is printed with only the fluorescent ink and a light amount distribution (hereinafter, also referred to as light amount distribution (b)) when one of nozzles corresponding to the normal ink is defective and does not discharge ink in a case where an image is printed with only the normal ink. In the light amount distribution (a), as explained in FIG. 6, both the visible light and the ultraviolet light as the irradiation lights are reflected as the visible light from the region (fluorescent ink region) on which dots with the fluorescent ink are formed. On the other hand, the visible light is reflected as the visible light and the ultraviolet light is reflected as ultraviolet light from the region (no-ink region) on which dots with the fluorescent ink are not formed because the defective nozzle is caused. Therefore, in the light amount distribution based on the energy of the visible light, the light amount of the visible light is significantly varied in the decreasing direction in the no-ink region in comparison with light amounts in the peripheral regions.

In the light amount distribution (b), as explained in FIG. 6, both the visible light and the ultraviolet light as the irradiation lights are absorbed in the region (normal ink region) on which dots with the normal ink are formed. On the other hand, the visible light is reflected as visible light and the ultraviolet light is reflected as ultraviolet light from the region (no-ink region) on which dots with the ink are not formed because the defective nozzle is caused. Therefore, in the light amount distribution based on the energy of the visible light, the light amount of the visible light is significantly varied in the increasing direction in the no-ink region in comparison with light amounts in the peripheral regions.

Normal image data (for example, figure photographs, graphics, and the like) is formed as dots on the print sheet P with the normal ink and the fluorescent ink in a mixed state. In this case, a distribution in which the above described two light amount distributions are added is obtained. Further, a discharge amount of ink from each nozzle on each raster is different depending on the images. Therefore, even if the defective nozzle is not caused, the light amount distribution is moderately varied.

Then, in order to judge whether there is a probability that the defective nozzle is caused, the CPU 30 calculates a light variation amount (hereinafter, also referred to as light amount variation) for each raster in the light amount distribution corresponding to the printed image data D. FIG. 7B is a descriptive view for explaining the light amount variation calculated by the CPU 30. FIG. 7B illustrates a light amount distribution of the image data D. As shown in FIG. 7B, the raster of which light amount variation is calculated is set to a raster-to-be-focused (y). Further, a differential value between a light amount g(y) of the raster-to-be-focused and an average value of a light amount g(y+ε) and a light amount g(y−ε) of the rasters (ε) which are in the vicinity of the raster-to-be-focused is set to the light amount variation (hereinafter, also referred to as |Δg(y)|).

The CPU 30 sets a raster number of the raster-to-be-focused to y=1 (step S135 in FIG. 3). Then, the CPU 30 calculates the light amount variation of the raster number 1 and compares the light amount variation with a predetermined threshold value σ(y) so as to judge whether there is a probability that the defective nozzle is caused (step S140). The threshold value σ(y) is a threshold value which has been previously calculated based on the dot number data (that is, formation amount of ink dots on each raster) calculated in step S110. If the light amount variation is smaller than the threshold value σ(y) (step S140: No), it is judged that there is no probability that the defective nozzle is caused. Then, the raster number y of the raster-to-be-focused is incremented (step S145) and the above processings from step S140 are repeated for all of the rasters in the image data D (raster number is set to be m) (step S150). If the light amount variation of each of all the rasters in the image data D is smaller than the threshold value σ(y), that is, if it is judged that a defective nozzle is not caused in printing of the first image data D and the printing error is not caused, the print number k is incremented (step S155). Then, the above processings from step S120 are repeatedly executed until the print number k becomes larger than the set number value n, that is, until n pieces of image data D is printed (step S160).

On the other hand, if the light amount variation is larger than the threshold value σ(y) (step S140: Yes), it is judged that there is a probability that the defective nozzle is caused. Therefore, a defective nozzle identification processing for detecting the defective nozzle precisely to identify the defective nozzle is performed. To be more specific, the variation amount G of the number of dots (hereinafter, also referred to as dot number variation) on the raster (y) of which light amount variation is larger than the threshold value σ(y) in the dot number data (see, FIG. 4) for each ink color generated in step S110 is calculated. The dot number variation of ink color H (H is any one of ink colors of C, M, Y, K, and F) on the raster (y) is expressed by |ΔG(H, y)|. The dot number variation is calculated by a difference between the number of dots on the raster (y) and the number of dots on rasters (y±ε) in the vicinity of the raster (y). Then, magnitudes of the dot number variation for each ink color H and a predetermined threshold value ξ(H, y) are compared with each other so as to calculate whether there is an ink color H satisfying |ΔG(H, y)|>ξ(H, y) (step S165). The threshold value ξ(H, y) is a value which has been previously calculated with respect to the dot number variation on the raster of which light amount variation is equal to or not lower than σ(y) based on the dot number data. That is to say, it is judged whether a large variation in the light amount distribution in step S140 is caused by a dot pattern of the image data D (that is, by nature of an original image).

Then, if there is an ink color H satisfying |ΔG(H, y)|>ξ(H, y) (step S165: Yes), that is, if a large variation in the light amount distribution is caused by the dot pattern of the image data D, it is judged that there is no defective nozzle and the process is returned to step S145. On the other hand, if there is no ink color H satisfying |ΔG(H, y)|>ξ(H, y) (step S165: No), that is, if a large variation in the light amount distribution is not caused by the dot pattern of the image data D, it is judged that the large variation in the light amount distribution is caused by the defective nozzle at higher possibility (step S170). Then, the defective nozzle identification processing for identifying the defective nozzle among a plurality of nozzles on the printer head 70 is executed (step S180). The defective nozzle identification processing is described later.

In the defective nozzle identification processing, when the defective nozzle is not detected (step S190: No), the process is returned to step S155. On the other hand, in the defective nozzle identification processing, when the defective nozzle is detected (step S190: Yes), a predetermined restoration processing is performed on the identified defective nozzle (step S195). As the restoration processing of the defective nozzle, for example, the CPU 30 transmits a control signal to the identified defective nozzle, or a nozzle group formed with a plurality of nozzles including the identified defective nozzle so as to discharge ink at high pressure. Then, the CPU 30 controls the vibration of the piezoelectric device included in each nozzle so as to clean the nozzle and eliminate the clogging of the nozzle. After the restoration processing of the defective nozzle is finished, the process is returned to step S160.

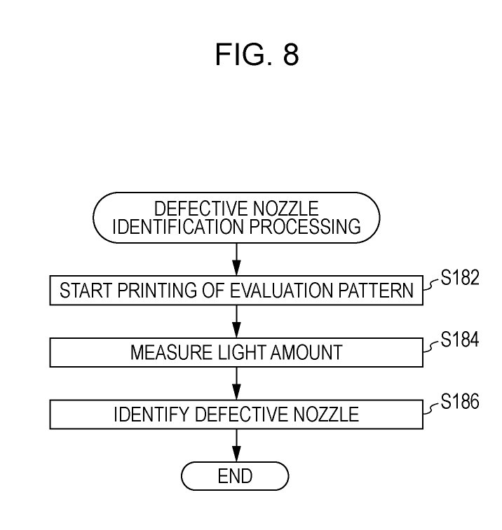

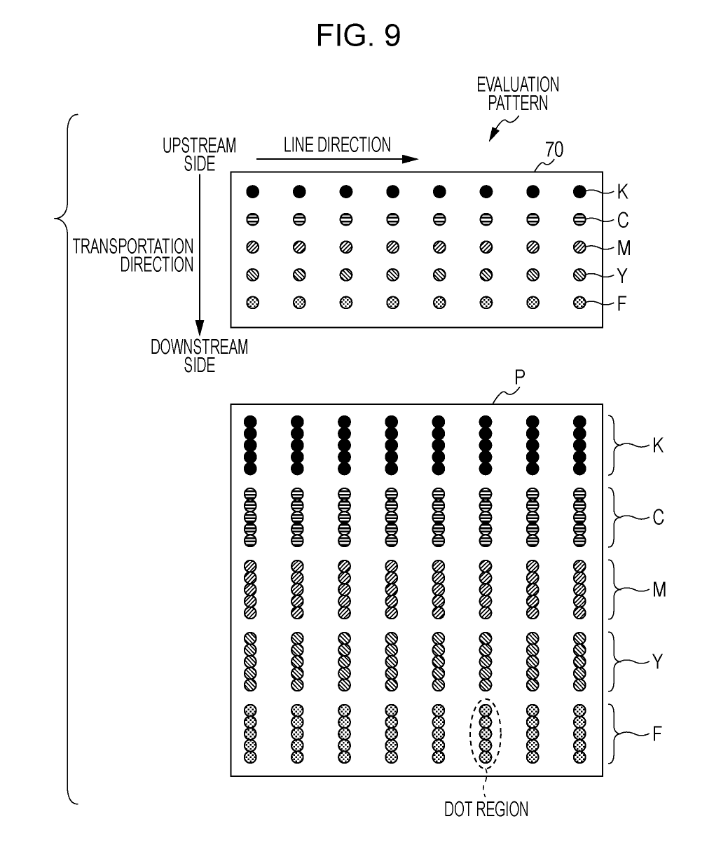

Next, the defective nozzle identification process in step S180 is described. FIG. 8 is a flowchart for explaining a flow of the defective nozzle identification processing. If the CPU 30 starts the defective nozzle identification processing, a printing of an image for evaluating the defective nozzle (hereinafter, also referred to as evaluation pattern) is started (step S182). The CPU 30 reads image data relating to the evaluation pattern which has been previously stored in the ROM 50 so as to start printing. FIG. 9 is a descriptive view for explaining the evaluation pattern. The evaluation pattern is an image in which dots with ink discharged from each nozzle 701 are arranged by a predetermined number of dots vertically and horizontally. At this time, each block includes a predetermined number of dots. A region on the evaluation pattern, which is formed with ink dots discharged from one nozzle, is also referred to as a dot formation region. Each dot formation region is arranged such that at least a part of each dot formation region is not superimposed with other dot formation regions. Accordingly each dot formation region in the evaluation pattern has one-to-one correspondence to each nozzle on the printer head 70. It is to be noted that 100 dots are formed in one dot formation region so as to be arranged in a row in the transportation direction in the embodiment.

When printing of such an evaluation pattern is started, dots are formed by the printer head 70 in accordance with the evaluation pattern. Then, the dots are irradiated with the irradiation light by the light source 61 and the energy of the reflected light is measured. The measured energy of the reflected light is integrated for each of the regions so as to calculate a light amount for each dot formation region (step S184). To be more specific, the energy of the received reflected light is integrated in the direction of the length of the dot formation region (length of 100 dots) for each dot formation region so that the integrated value is set to the light amount of the dot formation region. The CPU 30 controls the timing of measuring the light amount based on the transportation speed of the print sheet P and the timing of discharging ink from each nozzle so as to measure the light amount for each dot formation region in the evaluation pattern.

Then, as a result of measurement of the light amount for each dot formation region, when there is a dot formation region indicating a significant variation of the light amount in comparison with that of the peripheral dot formation regions of the same ink color, the nozzle corresponding to the dot formation region is identified as a defective nozzle (step S186). The CPU 30 performs the defective nozzle identification processing in such a manner.

As described above, the printer 10 according to the embodiment performs the printing based on the image data D while performing a determination processing whether there is a probability that the defective nozzle is caused on the printer head 70 by analyzing the light amount distribution of the reflected light through the print sheet P based on the irradiation light. In only a case where it is judged that there is a probability that the defective nozzle is caused with the determination, the precise detection and identification of the defective nozzle are performed. With such processing steps, the printing of the image data D can be smoothly performed while detecting the defective nozzle.

Further, since the defective nozzle is detected based on the light amount of the reflected light through the printing medium, a sensor corresponding to the nozzles of each ink color is not required to be provided for each ink color included by the printer 10. In the other words, even if the types of ink colors used for the printing processing by the printer 10 is increased, the number of sensors for detecting the defective nozzle is not required to be increased. This makes it possible to simplify a configuration of the printer 10.

Further, in the embodiment, lights having wavelength components in regions from the ultraviolet light region to the visible light region are used as the irradiation lights. On the other hand, light amount is calculated by using only light having the wavelength component in the visible light region among the reflected lights so as to detect the defective nozzle. Therefore, even when the fluorescent ink (F) is used in addition to the normal ink (in the embodiment, C, M, Y, and K), the defective nozzle can be detected.

Correspondence relationships between the embodiment and the scope what is claimed is are as follows. The energy of the reflected light in the embodiment corresponds to light intensity for detection and light intensity for identification in the scope what is claimed is and the defective nozzle detector in the embodiment corresponds to a defective nozzle detector and a defective nozzle identification unit in the scope what is claimed is.

### B. Modification

It is to be noted that the invention is not limited to the above embodiment and the mode for carrying out the invention and may be executed in various modes in a range without departing from the scope of the invention. For example, the following modifications can be made.

### B1. Modification 1:

In the embodiment, lights having wavelength components in regions from the ultraviolet light region to the visible light region are used as the irradiation lights. However, when the printer 10 performs printing by using only the normal ink, light having a wavelength component in only one of the ultraviolet light region and the visible light region may be used as the irradiation light. The normal ink absorbs any of light having the wavelength component in the visible light region and light having the wavelength component in the ultraviolet light region. Further, both lights are reflected by no-ink region on which dots with the normal ink are not formed (see, FIG. 6). Accordingly, even when only one of the lights is used as the irradiation light, the no-ink region and the normal ink region can be detected with the variation in the light amounts of the reflected lights. As a result, in a case where printing is performed by using only the normal ink, even when light having a wavelength component in only one of the ultraviolet light region and the visible light region is used as the irradiation light, the defective nozzle can be detected. However, in a case where only light having the wavelength component in the ultraviolet light region is used as the irradiation light, an integrated value obtained by integrating energy of the light having the wavelength component in the ultraviolet light region is used as calculation of the light amount.

Further, in contrast thereto, in a case where the printer 10 performs printing by using only the fluorescent ink, light having the wavelength component in only the ultraviolet light region may be used as the irradiation light. If the fluorescent ink is irradiated with either of the visible light or the ultraviolet light, the reflected light therefrom becomes light having the wavelength component in the visible light region. Accordingly, if only the ultraviolet light is used as the irradiation light, and an integrated value obtained by integrating only energy of the light having the wavelength component in the visible light region among the reflected lights received by the photosensor 65 is employed as the light amount, the defective nozzle can be also detected even when printing is performed by using only the fluorescent ink. With this, the same effects as those in the embodiment can be obtained.

### B2. Modification 2:

In the above embodiment, the photosensor 65 receives reflected lights having all the wavelength components and the energy of the light having a wavelength component in the visible light region is selectively integrated at a processing stage of calculating the light amount. However, a configuration in which a filter which shuts out only the light having the wavelength component in the ultraviolet light region is arranged between the photosensor 65 and the print sheet P on a light path of the reflected lights, and the photosensor 65 calculates the light amount based on the energy of the reflected light from which light having the wavelength component in the ultraviolet light region is removed may be employed. With this configuration, the same effects as those in the embodiment can be obtained.

### B3. Modification 3

In the above embodiment, C, M, Y, and K are used as the normal ink. However, the normal ink is not limited thereto and any inks can be used as the normal ink as long as the inks absorb light having the wavelength component in the visible light region. As the normal ink, particular color inks such as red (R), green (Gr), orange (Or), and the like, and light color inks such as light cyan (Lc), light magenta (Lm), gray (Lk), light gray (LLk), and the like can be used, for example. The particular color inks and the light color inks are used to enlarge a reproduction region of colors. If such inks are used as the normal ink, the same effects as those in the embodiment can be obtained.

### B4. Modification 4:

In the above embodiment, the defective nozzle is detected and identified based on the reflected light reflected by the printing medium based on the irradiation light. However, the defective nozzle may be detected and identified based on transmission light transmitted through the printing medium based on the irradiation light. In this case, a light source is arranged on one side of an optical path of the irradiation light across the printing medium to be transported and a photosensor is arranged on the other side thereof. Further, the transmission light that the irradiation light irradiated from a light source is transmitted through the printing medium is received by the photosensor. With this, the same effects as those in the embodiment can be obtained.

What is claimed is:

1. A printing apparatus which prints a print image onto a printing medium based on image data, comprising:
a plurality of nozzles which discharge ink onto the printing medium based on the image data while relatively moving with respect to the printing medium;
an intensity detector which irradiates the printing medium with irradiation light to detect a light intensity for detection which is an intensity of light through the printing medium based on the irradiation light; and
a defective nozzle detector which detects a bias of a distribution of dots with the ink formed on the printing medium based on the light intensity for detection to judge whether a defective nozzle is caused based on the bias of the distribution of the dots.

2. The printing apparatus according to claim 1, further comprising a defective nozzle identification unit which prints a predetermined evaluation pattern image onto a printing medium to identify the defective nozzle based on the evaluation pattern image when the defective nozzle detector judges that there is a probability that the defective nozzle is caused,
wherein the evaluation pattern image is an image in which at least a part of each dot formation region on which each ink discharged from each of the plurality of nozzles lands on the printing medium to form ink dots in each region is not superimposed with other dot formation regions, and
the defective nozzle identification unit irradiates the evaluation pattern with the irradiation light to identify the defective nozzle based on a light intensity for identification which is an intensity of light corresponding to each of the dot formation regions among lights through the evaluation pattern based on the irradiation light.

3. The printing apparatus according to claim 1,
wherein the defective nozzle detector generates a light amount distribution which is a distribution of a light amount based on the light amount obtained by integrating the light intensity for detection in the relative movement direction to detect the bias of the distribution of the dots based on the light amount distribution.

4. The printing apparatus according to claim 1,
wherein the irradiation light contains a wavelength component in a visible light region,
the intensity detector detects an intensity of light having the wavelength component in the visible light region as the light intensity for detection, and
the ink is ink which absorbs light having the wavelength component in the visible light region and light having a wavelength component in an ultraviolet light region.

5. The printing apparatus according to claim 1,
wherein the irradiation light contains the wavelength component in the ultraviolet light region,
the intensity detector detects an intensity of light having the wavelength component in the visible light region as the light intensity for detection, and
the ink includes ink which reflects the light having the wavelength component in the visible light region as light having the wavelength component in the visible light region, and reflects the light having the wavelength component in the ultraviolet light region as light having the wavelength component in the ultraviolet light region.

6. The printing apparatus according to claim 4,
wherein ink which absorbs light having the wavelength component in the visible light region and light having the wavelength component in the ultraviolet light region is ink including cyan (C) ink, magenta (M) ink, and yellow (Y) ink.

7. The printing apparatus according to claim 5,
wherein ink which reflects the light having the wavelength component in the visible light region as light having the wavelength component in the visible light region and reflects the light having the wavelength component in the ultraviolet light region as light having the wavelength component in the visible light region includes ink of fluorescent color.

8. The printing apparatus according to claim 1,
wherein the defective nozzle detector judges whether the defective nozzle is caused based on the bias of the distribution of the dots and the image data.

9. A method for printing which prints a print image onto a printing medium based on image data, comprising:
discharging ink onto the printing medium by using a plurality of nozzles based on the image data while relatively moving with respect to the printing medium;
detecting a light intensity for detection which is an intensity of light through the printing medium based on the irradiation light by irradiating the printing medium with irradiation light;
detecting a bias of a distribution of dots with the ink formed on the printing medium based on the light intensity for detection; and
judging whether a defective nozzle is caused based on the bias of the distribution of the dots.
